(19) United States
(12) Patent Application Publication
(10) Pub. No.: US 2026/0168861 A1
(43) Pub. Date: Jun. 18, 2026

(54) OPTICAL SHUTTERS FOR SENSING APPLICATIONS

(71) Applicant: TEXAS INSTRUMENTS INCORPORATED, Dallas, TX (US)

(72) Inventors: Jonathan Doylend, Savannah, MO (US); Yogesh Ramadass, San Jose, CA (US); Baher S. Haroun, Allen, TX (US)

(21) Appl. No.: 19/195,531

(22) Filed: Apr. 30, 2025

Related U.S. Application Data
(60) Provisional application No. 63/733,586, filed on Dec. 13, 2024.

(51) Int. Cl. G01J 5/08; G01J 5/02; G01J 5/0806

(52) U.S. Cl. CPC G01J 5/0816; G01J 5/026; G01J 5/0806

(57) ABSTRACT

An apparatus is described, which includes a die including a sensor. In an example, the apparatus includes an optical shutter layer that statically overlaps with at least part of the sensor of the die. In an example, the optical shutter layer has a configurable transparency to a light signal responsive to an electrical signal. In an example, the optical shutter layer is configurable to: in a first mode, steer a light signal to the sensor; and in a second mode, steer the light signal away from the sensor.

### CLAIM OF PRIORITY

This application claims priority to U.S. Provisional Patent Application No. 63/733,586 titled “OPTICAL SENSOR SHUTTER” filed Dec. 13, 2024, which is incorporated by reference in its entirety.

### BACKGROUND

An infrared (IR) thermometer comprises a sensor that is configurable to estimate a temperature of a target object, by measuring an infrared radiation emitted by the target object. An object emits infrared radiation according to its temperature, also referred to as blackbody radiation. The emitted infrared radiation behaves in accordance with optical principles. In an example, a wavelength of the spectrum of this IR radiation may range from 0.7 micrometer (μm) to 1000 μm. In another example, the human body emits radiation with a peak emission wavelength between 5 μm and 10 μm as per Planck's Law. As described above, the sensor of an IR thermometer is configurable to measure the IR radiation from a target object, and estimate a temperature of the target object.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIGS. 1A, 1B, 1C, 1D, and 1E are schematics illustrating a sensing system and its operations, in accordance with some examples.

FIGS. 2A, 2B, and 2C are schematics illustrating circuitries of a sensing system, in accordance with some examples.

FIGS. 3A and 3B are schematics illustrating an optical shutter layer of a sensing system, in accordance with some examples.

FIG. 4 is a schematic illustrating an optical shutter layer implemented using a transistor, in accordance with some examples.

FIGS. 5A and 5B are schematics illustrating a sensing system, in accordance with some examples.

FIGS. 6A and 6B are schematics illustrating an optical shutter layer, in accordance with some examples.

FIG. 7 is a schematic illustrating a sensing arrangement, in accordance with some examples.

FIG. 8 is a schematic illustrating a sensing arrangement, in accordance with some examples.

FIG. 9 illustrates a flowchart depicting a method for operating a sensing system including an optical shutter layer, in accordance with some examples.

### SUMMARY

In an example, an apparatus comprises a die including a sensor. In an example, the apparatus further comprises an optical shutter layer that statically overlaps with at least part of the sensor of the die. In an example, the optical shutter layer has a configurable transparency to a light signal responsive to an electrical signal. In an example, the optical shutter layer is configurable to: in a first mode, steer a light signal to the sensor; and in a second mode, steer the light signal away from the sensor.

In an example, an apparatus comprises a die including a sensor. In an example, the apparatus further comprises a layer configurable to vary an intensity of a light signal that is incident upon the sensor by at least one of: varying the intensity of the light signal that propagates through the layer onto the sensor, or steering at least some of the light signal away from the sensor.

In an example, a system comprises a die including a sensor. In an example, the system further comprises an enclosure on the sensor. In an example, the enclosure includes a layer that is configurable to vary an intensity of a light signal propagates through the layer and is incident upon the sensor. In an example, the system further comprises a signal estimation circuitry configured to estimate a parameter by (i) measuring a first output of the sensor during a first state of the layer, and (ii) measuring a first second of the sensor during a second state of the layer.

In an example, a method comprises setting an optical shutter layer to a first state. In an example, the method further comprises setting the optical shutter layer to a second state. In an example, the method further comprises detecting, using a sensor that overlaps with the optical shutter layer, a first light signal when the optical shutter layer is in the first state. In an example, the method further comprises detecting, using the sensor, a second light signal when the optical shutter layer is in the second state. In an example, the method further comprises determining a physical parameter responsive to the detection of the first and second light signals. In an example, the physical parameter is a temperature.

### DETAILED DESCRIPTION

Disclosed herein is a sensing system that can sense a light signal emitted from a target object and measure a physical property of the target object, wherein the sensing system comprises an optical shutter layer that can eliminate (or at least reduce) effects of crosstalk in the measurement process. In an example, the light signal is an infrared (IR) light signal. For example, an IR thermometer comprises a sensor that is configurable to sense an infrared radiation emitted by the target object, and a processing circuit that is configurable to determine a temperature based on an output of the sensor. The sensor may include be a thermopile, a photodiode, a bulk acoustic wave (BAW) detector, an infrared camera, etc.

However, while the light signal of interest (such as an IR light signal) from the target object reaches the sensor, thermal inputs from other sources may also reach the sensor in the form of crosstalk or noise, which can introduce error to the sensing/measurement of the light signal of interest and the resulting temperature measurement. The crosstalk may be IR radiated or conducted thermal energy from one or more other non-target sources, such as from a die on which the sensor is mounted, from the substrate of the sensor itself, from circuitry of the sensing system or adjacent circuits, and/or the like, as described below in further detail.

In an example, an optical shutter layer is placed in front of the sensor, in which the optical shutter layer is statically placed with respect to the sensor. For example, the optical shutter layer statically overlaps with at least part of the sensor. In operation, the optical shutter may be positioned to face a target. The optical shutter may alternate between a first state and a second state, in which in the first state the optical shutter allows a target light signal from the target to pass through the optical shutter layer and reach the sensor, and in the second state the optical shutter at least in part prevents the target light signal from reaching the sensor (e.g., by blocking or diverting the target light signal). In contrast, the crosstalk, which may originate within or external to the sensing system, may still reach the sensor. The sensing system can then obtain a measurement of the target light signal based on determining a difference between the amount of light signal received between the first state (which can include the target light signal and crosstalk) and the second state (which can include primarily the crosstalk), to advantageously eliminate, or at least reduce, effects of the crosstalk on the measurement of the target light signal.

In some examples, the optical shutter layer is configurable to vary an amount of the target light reaching the sensor from the target object. For example, the optical shutter layer operates (i) at a first time period, in a first state (e.g., a pass state of operation), and (ii) at a second time period, in a second state (e.g., a block state of operation). For example, an attribute of the optical shutter layer is varied, where the attribute has a first value during the pass state of the optical shutter layer and has a second value during the block state of the optical shutter layer. As a result, while in the pass state, the optical shutter layer allows the target light signal from the signal source to reach the sensor. On the other hand, while in the block state, the optical shutter layer blocks or partially attenuates the target light signal from the signal source from reaching the sensor.

In some examples, the attribute can be a transparency of the optical shutter layer at the wavelength of the target light signal, and the optical shutter layer has a configurable transparency. Because of the configurable transparency, the optical shutter layer is configurable to allow the target light signal to reach the sensor, or stop at least a part of the target light signal from reaching the sensor. Thus, the optical shutter layer can operate as a chopper, to at least in part chop/block/attenuate the target light signal that reaches the optical shutter during the block state, and to allow the target light signal to pass through it and reach the sensor during the pass state. Accordingly, the amount (e.g., intensity) of the target light signal that reaches the sensor through the optical shutter can be higher (such as several order of magnitudes higher) in the pass state than in the block state.

In some examples, the optical shutter layer comprises a semiconductor material, such as silicon. Intrinsic silicon (such as relatively lowly doped or undoped silicon) is relatively more transparent at the wavelength range of the target light signal (such as having a mid-IR wavelength of 4 μm to 12 μm), whereas relatively highly doped silicon is relatively opaque at this wavelength range due to free carrier absorption. Thus, as described below in further detail, a free carrier concentration of the optical shutter layer is dynamically configurable to set a transparency of the optical shutter layer in the wavelength range of the target light signal.

Various techniques to dynamically configure the free carrier concentration within the optical shutter layer, and hence its transparency, have been described below. In some examples, the semiconductor material may include a PIN diode including a p-type region, an intrinsic region, and an n-type region, and the biasing of a PIN diode may be controlled, to vary a free carrier concentration of the intrinsic region of the optical shutter layer, thereby modulating the transparency of the intrinsic region of the optical shutter layer, as described below in further detail. In some examples, the optical shutter layer comprises at least a channel region of a transistor, and the voltages to various terminals of the transistor may be appropriately controlled to vary a free carrier concentration of the channel region of the optical shutter layer, thereby modulating the transparency of the channel region of the optical shutter layer, as also described below in further detail.

In some examples, other attributes of the optical shutter layer that can affect the transmission of the target light signal to the sensor are configurable. For example, the optical shutter layer may include a piezoelectric film. The sensing system may include control circuitry configurable to vary a periodicity of a refractive index modulation of the piezoelectric film, thus creating an optical diffraction grating that can be dynamically tuned by electrical signals. During the pass state, the optical shutter layer can be configured to steer the target light signal towards the sensor. On the other hand, during the block state, the optical shutter layer can be configured to steer the target light signal away from the sensor, either in whole or in part. For example, the piezoelectric film of the optical shutter layer can form a Bragg cell, to control or steer a direction of the target light signal from the optical shutter layer, as described below in further detail.

Also, the crosstalk may reach the sensor in both the pass state and the block state of the optical shutter. Accordingly, the sensor receives the crosstalk during both the pass state and the block state of the optical shutter layer. In contrast, the sensor receives different amounts of the target light signal in the pass state and in the block state of the optical shutter. Accordingly, the outputs of the sensor during the pass state and the block state may be used to estimate the target light signal, with effects of the crosstalk removed, or at least reduced, from the estimate of the target light signal, e.g., as described below in further detail.

In some examples, the amounts of light signals (including target light signal and cross talk) received by the sensor in a particular instance of the pass state and in a particular instance of the block state of the optical shutter layer can be used to determine the amount of the target light signal received from the target. In another example, the sensing system causes the optical shutter layer to toggle between the pass state and the block state at a frequency, and perform multiple measurements of the received light signals in the multiple instances of the pass state and in the multiple instances of the block state. The multiple measurements may be averaged to provide a better estimation of the target light signal, as also described below in further detail. In some examples, a bandpass filter may be applied to the sensor output such that only signal that is modulated at the shutter frequency is accepted while other frequency components are rejected or attenuated, thus eliminating or mitigating thermal inputs which have not passed through and thus have not been modulated by the optical shutter's pass and block frequency.

Numerous configurations and examples of the sensing system and the optical shutter layer are described below in further detail.

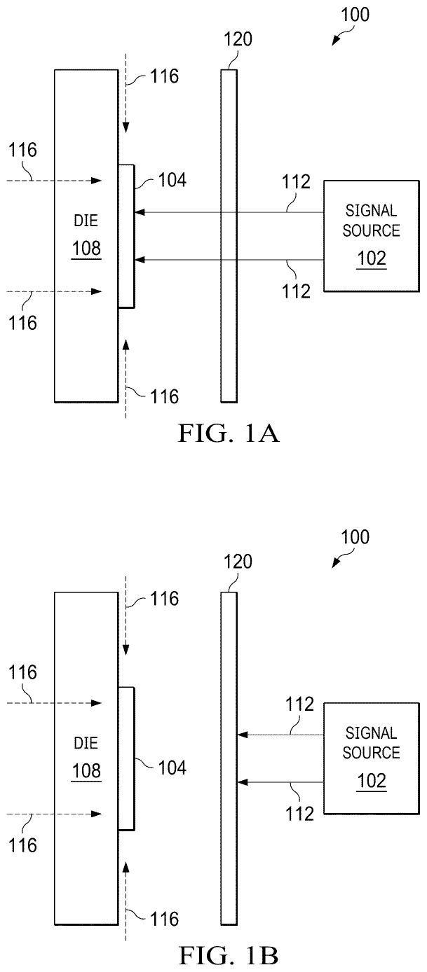

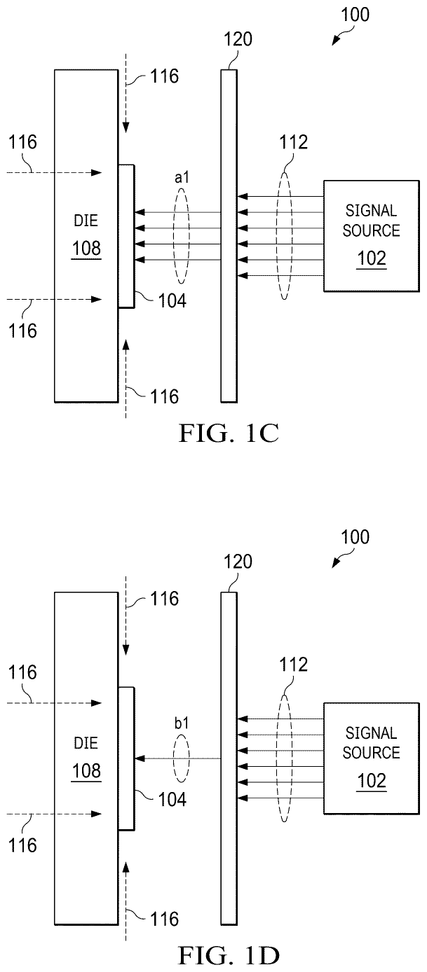

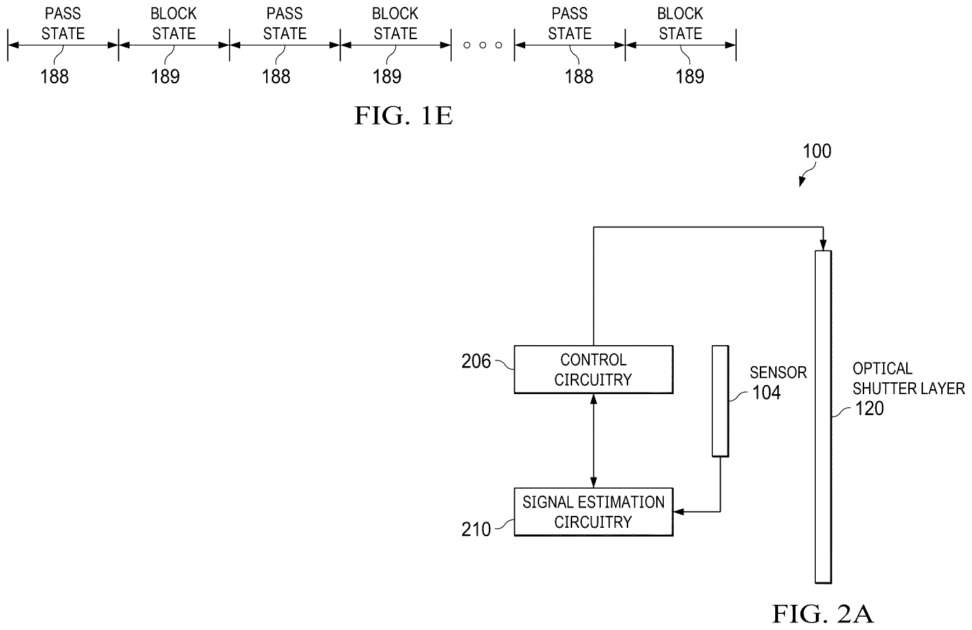

FIGS. 1A and 1B are schematics illustrating a sensing system 100, according to some examples. Sensing 100 includes an optical shutter layer 120 on a sensor 104, wherein optical shutter layer 120 has a configurable transparency to a light signal 112 responsive to an electrical signal. Both optical shutter layer 120 and die 108 are mounted statically with respect to each other (e.g., within a housing not shown in the figures). FIG. 1A also illustrates an operation of sensing system 100 when optical shutter layer 120 is in a pass state, and FIG. 1B illustrates an operation of sensing system 100 when optical shutter layer 120 is in a block state.

Sensing system 100 of FIGS. 1A and 1B includes sensor 104 mounted on a die 108. The sensor 104 can sense a light signal, and provide an output representing, for example, an amount (e.g., an intensity) of the sensed light signal. In an example, sensor 104 is a thermal sensor, such as a non-contact thermal sensor. In the example of FIGS. 1A and 1B, sensor 104 senses infrared (IR) light signal 112 emitted by a signal source 102, and provides an output representing the amount of the sensed light signal 112. A processing circuit (not shown in FIGS. 1A and 1B), or the sensor itself, can also provide a signal presenting an estimation of a temperature of signal source 102 based on the sensed light signal 112. For example, signal source 102 emits infrared radiation due to its temperature. Light signal 112 is based on a temperature of signal source 102. Signal source 102 can be any signal source, whose temperature is to be measured, such as a human body or another thermal source. Sensor 104 senses light signal 112, and generates an output. Backend circuitry of sensing system 100 (such as a signal estimation circuitry 210 described below) senses output of sensor 104, and estimates a temperature of signal source 102. As described above, sensor 104 is mounted on an integrated circuit (IC) chip or die 108.

IR light signal 112 sensed by sensor 104 has, for example, a wavelength range of 780 nanometers (nm) to 1 millimeter (mm). For example, IR light signal 112 sensed by sensor 104 has a wavelength range of 4 micrometers (μm) to beyond 8 μm.

Sensor 104 may include any sensor that can sense light signals. For example, sensor 104 may be a thermopile, a photodiode, a bulk acoustic wave (BAW) detector, or an infrared camera. For example, the techniques described herein may be used for a sensing scenarios where signal source 102 cannot be directly modulated (e.g., signal source cannot be turned off or reduced, and/or either prevented from emitting light signal 112 or caused to emit reduced light signal 112).

Sensor 104 receives light signal 112 from signal source 102, as well as thermal crosstalk 116 (illustrated as dotted lines in FIGS. 1A and 1B) from other sources. The crosstalk 116 may have wavelength in same range as light signal 112 of interest. For example, where light signal 112 of interest is an IR signal, crosstalk 116 may also be IR radiation. Accordingly, crosstalk 116 adds unwanted noise which interferes with the accurate measurement of light signal 112 of interest, thereby possibly causing error in measurement of light signal 112 of interest by sensor 104.

Specifically, in examples where sensor 104 comprises a photodiode, crosstalk light signals 116 may represent collected infrared inputs from any non-target sources. In examples where sensor 104 comprises a thermopile, crosstalk thermal inputs 116 may be representative of heating of a cold junction of the thermopile. Also, crosstalk thermal inputs 116 may be representative of background temperature of die 108 and/or sensor 104 itself, and/or thermal power, whether conducted or radiated, from one or more other IC packages and dies placed proximally to sensor 104. Thus, crosstalk 116 may be representative of any noise, light crosstalk, or thermal crosstalk experienced by sensor 104 during a course of its operation.

In FIGS. 1A and 1B, signal source 102 is placed in front of sensor 104 and die 108. Thus, signal source 102 faces sensor 104. An optical shutter layer 120 is placed in between signal source 102 and sensor 104. As illustrated, light signal 112 from signal source 102 traverses through optical shutter layer 120 to reach sensor 104. In contrast, crosstalk 116 can each sensor 104 from other directions not through optical shutter layer. Thus, in the examples shown in FIGS. 1A and 1B, crosstalk 116 does not pass through optical shutter layer 120.

The optical shutter layer 120 is statically placed on sensor 104. For example, optical shutter layer 120 statically overlaps with at least part of sensor 104 of die 108. Thus, optical shutter layer 120 does not move relative to sensor 104, and hence overlaps with (e.g., is in front of and on) at least part of sensor 104 in both pass state (as shown in FIG. 1A) and block state (as shown in FIG. 1B).

FIGS. 1A and 1B illustrate two example states of operation of optical shutter layer 120, such as a pass state illustrated in FIG. 1A, and a block state illustrated in FIG. 1B. For example, in FIGS. 1A and 1B, an attribute of optical shutter layer 120 is varied. As a result, in FIG. 1A (e.g., during the pass state), optical shutter layer 120 allows at least some of light signal 112 from signal source 102 to reach sensor 104. On the other hand, in FIG. 1B (e.g., during the block state), optical shutter layer 120 blocks (or at least attenuate) at least some of light signal 112 from signal source 102 from reaching sensor 104. Accordingly, optical shutter layer 120 acts as a chopper, and the amount (e.g., intensity) of light signal 112 that reaches sensor 104 is lower in the block state than in the pass state.

In some examples, optical shutter layer 120 comprises a semiconductor material, such as silicon or other types of semiconductor material. Intrinsic silicon (such as relatively lowly doped or undoped silicon e.g. between 1E13 cm⁻³ and 1E17 cm⁻³ boron or phosphorus or arsenic doping as an example) is relatively more transparent at wavelength range of light signal 112 (such as having a mid-IR wavelength of 4 μm to 12 μm), whereas relatively highly doped silicon (e.g. 1e17 cm⁻³ to 1e20⁻³ or higher of either boron or phosphorus or arsenic or similar) is relatively opaque at this wavelength range due to free carrier absorption. Free carrier absorption in silicon as a function of free carrier density is given by following equation:

$$Δ α = \frac{{c}^{3} {λ}_{0}^{2}}{4 {π}^{2} {c}^{3} {ε}_{0} n} [ \frac{{N}_{e}}{{{μ}_{e} ( {m}_{c e}^{*} )}^{2}} + \frac{{N}_{h}}{{{μ}_{h} ( {m}_{c h}^{*} )}^{2}} ] \qquad Equation l$$

In equation 1, Δα is a change in an absorption coefficient of light signal or some related optical property, c is the speed of light in vacuum, and λ₀ is a characteristic wavelength, such as a wavelength of incident light signal 112. ε₀ is permittivity of free space, and n is a refractive index of the medium (e.g., silicon region of optical shutter layer 120). Nₑ is a carrier concentration of electrons. Nₕ is a carrier concentration of holes. He is a mobility of electrons. μₕ is a mobility of holes. m_{ce} is an effective mass of conduction-band electrons. m_{ch} is an effective mass of valence-band holes.

Equation 1 describes how free carrier absorption changes as a function of charge carrier concentration in a material of optical shutter later 120. By introducing variable free-carrier concentration within one or more regions of optical shutter layer 120, a transparency of these regions of optical shutter layer 120 at infrared wavelength range of interest may be controlled and varied, as will be described below in further detail. For example, by modulating free-carrier concentration of electrons and/or holes within one or more regions of optical shutter layer 120, optical shutter layer 120 may be made relatively more transparent (or less opaque) during pass state 188 of optical shutter layer 120, and optical shutter layer 120 may be made relatively less transparent (or more opaque) during block state 189 of optical shutter layer 120.

For example, by increasing a free carrier concentration within regions of optical shutter layer 120, such regions may be made relatively less transparent (or opaquer) during block state 189 of optical shutter layer 120. On the other hand, by decreasing free carrier concentration within regions of optical shutter layer 120, optical shutter layer 120 may be made relatively more transparent (or less opaque) during pass state 188 of optical shutter layer 120. Such variation in a transparency of optical shutter layer 120 causes optical shutter layer 120 to either allow or block light signal 112 from reaching sensor 104.

Note that as crosstalk 116 does not have to pass through optical shutter layer 120 to reach sensor 104, sensor 104 receives crosstalk 116 relatively unvaried during both the pass state and the block state optical shutter layer 120.

In the pass state of optical shutter layer 120, an output of sensor 104 is based on both light signal 112 and crosstalk 116, which is symbolically represented as follows:

$${Sensor}_{pass state} = light signal 112 + crosstalk 116 \qquad Equation 2$$

On the other hand, in block state 189 of optical shutter layer 120, an output of sensor 104 is based on crosstalk 116, which is symbolically represented as follows:

$${Sensor}_{block state} = crosstalk 116 \qquad Equation 3$$

Thus, crosstalk 116 is received substantially equally by sensor 104 during both pass state 188 and block state 189. In contrast, light signal 112 is received by sensor 104 during pass state 188 (and is at least partially blocked from reaching sensor 104 during block state 189).

Accordingly, light signal 112 of interest may be estimated as follows:

$$Light signal 112 = {Sensor}_{pass state} - {Sensor}_{block state} \qquad Equation 4$$

Thus, effects of crosstalk 116 during measurement of light signal 112 can be eliminated, or at least reduced, by operating optical shutter layer 120 in pass state 188 and block state 189, and using equation 4 described above.

FIGS. 1C and 1D are schematics illustrating example operations of an optical shutter layer 120 during a pass state and a block state of sensing system 100 of FIGS. 1A and 1B, respectively. For example, referring to FIG. 1C, during the pass state, optical shutter layer 120 directs, towards sensor 104, a percentage al of total light signal 112 incident on optical shutter layer 120. Similarly, referring to FIG. 1D, during the block state, optical shutter layer 120 directs, towards sensor 104, a percentage b1 of total light signal 112 incident on optical shutter layer 120, where al is higher than b1. For example, al may be at least 95%, or at least 90%, or at least 85%, or at least 80%, or at least 75%, or at least 70%, or at least 65%, or at least 60%, or at least 55%, or at least 50%. Similarly, for example, b1 may be at most 5%, or at most 10%, or at most 15%, or at most 20%, or at most 25%, or at most 30%, or at most 35%, or at most 40%. Thus, in an example, an intensity of light signal 112 reaching sensor 104 during pass state 188 may be higher than an intensity of light signal 112 reaching sensor 104 during block state 189 by at least 50%, or at least 70%, or at least 90%, or at least 100%, for example. Accordingly, equations 2-4 may be modified based on al and b1.

Thus, in FIG. 1C, in pass state 188 of optical shutter layer 120, an output of sensor 104 is based on a weighted portion of light signal 112 (e.g., weighted by al) and crosstalk 116, which is symbolically represented as follows:

$${Sensor}_{pass state} = a 1 * light signal 112 + crosstalk 116. \qquad Equation 5$$

On the other hand, in block state 189 of optical shutter layer 120, an output of sensor 104 is based on a weighted portion light signal 112 (e.g., weighted by b1) and crosstalk 116, which is symbolically represented as follows:

$${Sensor}_{block state} = b 1 * light signal 112 + crosstalk 116. \qquad Equation 6$$

Thus, crosstalk 116 is received by sensor 104 during both pass state 188 and block state 189. In contrast, weighted portions of light signal 112 are received by sensor 104 during pass state 188 and during block state 189 (e.g., weighted by al and b1, respectively).

Accordingly, light signal 112 is estimated as follows:

$$Light signal 112 = ( {Sensor}_{pass state} - {Sensor}_{block state} ) / ( a 1 - b 1 ) . \qquad Equation 7$$

Weights al and b1 may be estimated during a calibration phase of sensing system 100. For example, one or more known temperatures of one or more objects may be measured by sensing system 100, and such measurements may be used to estimate weights al and b1.

Thus, in sensing system 100, light signal 112 from signal source 102 is modulated or varied, whereas crosstalk 116 remains unmodulated. Based on such variation of light signal 112 reaching sensor 104 and constant nature of crosstalk 116, light signal 112 of interest is estimated (e.g., effects of crosstalk 116 on estimation of light signal 112 is eliminated or at least reduced), as described above.

FIG. 1E is a schematic illustrating toggling between a pass state (labelled 188) and a block state (labelled 189) by optical shutter layer 120. For example, sensing system 100 (such as a control circuitry 206 described below) causes optical shutter layer 120 of FIGS. 1A-1D to toggle between pass state 188 and block state 189 with a configurable frequency f1.

For example, repeatedly toggling between pass state 188 and block state 189 allows multiple measurements of the light signals received by sensor 104. Accordingly, a processing circuit can generate multiple estimates of the intensity of light signal 112 according to equations 2-4 (or equations 5-7), and average the multiple estimates to provide a relatively accurate estimate of the intensity of light signal 112, and hence, a relatively more accurate estimate of temperature of signal source 102 (e.g., compared to a scenario where such toggling is not performed, and estimation is performed based on measurements during a single pass state 188 and a single block state 189).

In an example, frequency f1 at which optical shutter layer 120 operates (e.g., toggles between pass state 188 and block state 189) is configurable, and may be preselected for sensing system 100, e.g., by an operator of sensing system 100 and/or by a manufacturer of sensing system 100. The frequency f1 may be limited by one or more factors, such as (i) a response time of sensor 104 (e.g., how fast sensor 104 can provide a measurement during pass state 188, and then during block state 189), and (ii) how fast optical shutter layer 120 can transition between pass state 188, and then during block state 189. The response time of sensor 104 can be associated with a thermal sensing time of sensor 104, whereas the transition time of optical shutter layer 120 can be based on a time taken to change a carrier concentration (or another attribute) within optical shutter layer 120.

Time taken to change a carrier concentration (or another attribute, such as a grating periodicity described below) within optical shutter layer 120 may be in MHz (megahertz) range or even in GHz (gigahertz) range (e.g., may be based on a response time of a p-i-n junction diode included within optical shutter layer 120, as described below in further detail). In contrast, response time of sensor 104 may be based on a type of sensor used, and in an example, this response time may be slower than time taken to change a carrier concentration within optical shutter layer 120. Thus, in an example, frequency of operation f1 of optical shutter layer 120 may effectively be limited by response time of sensor 104. Thus, frequency f1 should be slow enough, such that sensor 104 has sufficient time to effectively measure and provide an output during each of pass state 188 and each block state 189 of optical shutter layer 120.

In an example, frequency f1 of operation may range from 0 (e.g., no toggling between pass state 188 and block state 189) to a few Hz, and may be as high in megahertz or even gigahertz range. In an example, frequency f1 of operation may be at least 1 Hz, or at least 2 Hz, or at least 5 Hz, or at least 10 Hz, or at least 20 Hz, or at least 100 Hz, or at least 500 Hz, or at least 1 kHz, or at least 10 kHz, or at least 100 kHz, or at least 500 kHz, or at least 1 MHz, or at least 10 MHz, or at least 500 MHz, or at least 1 GHz.

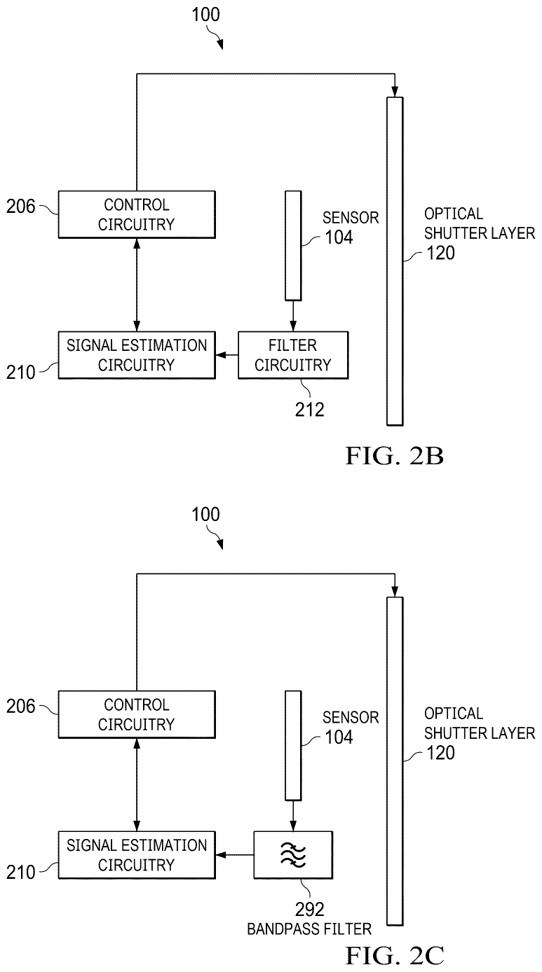

FIG. 2A is a schematic illustrating a control circuitry 206 and a signal estimation circuitry 210 of sensing system 100 of FIGS. 1A-1D. As illustrated, sensing system 100 includes sensor 104 and optical shutter layer 120. The die 108, on which sensor 104 is mounted, is not illustrated in FIG. 1D for purposes of illustrative clarity.

The sensing system 100 includes a control circuitry 206, which is configurable to set a state of optical shutter layer 120. For example, control circuitry 206 causes state of optical shutter layer 120 to change between pass state 188 and block state 189. In an example, control circuitry 206 causes optical shutter layer 120 to operate at preconfigurable frequency of f1, as described above. Operation of control circuitry 206 and changes of state of optical shutter layer 120 will be described below in further detail.

Sensing system 100 further includes a signal estimation circuitry 210. Signal estimation circuitry 210 communicates with control circuitry 206, e.g., to receive information about a current state of optical shutter layer 120, and about when a state of optical shutter layer 120 changes. Signal estimation circuitry 210 also receives the output of sensor 104. Signal estimation circuitry 210, for example, receives a first output of sensor 104 during pass state 188 of optical shutter layer 120, and also receives a second output of sensor 104 during block state 189 of optical shutter layer 120. Based on first output and second output and their associations with pass state 188 and block state 189, signal estimation circuitry 210 estimates light signal 112 received from signal source 102, e.g., as described above with respect to equations 2-7.

In an example where optical shutter layer 120 operates in accordance with preconfigured frequency f1, signal estimation circuitry 210 also averages estimate of light signal 112 over multiple cycles of pass state 188 and block state 189 of optical shutter layer 120.

Once signal estimation circuitry 210 estimates light signal 112, signal estimation circuitry 210 estimates a physical parameter of signal source 102, such as a temperature of signal source 102, based on estimate of light signal 112 received from signal source 102.

FIG. 2B is a schematic illustrating a control circuitry 206, a signal estimation circuitry 210, and a filter circuitry 212 of sensing system 100 of FIGS. 1A-1D. Thus, FIG. 2B includes the filter circuitry 212, which is not illustrated in FIG. 2A.

In FIG. 2B, a filter may be applied to the output of the sensor 104, such that only light signal 112, that is modulated at the shutter frequency f1 (see FIG. 1E) is accepted, while other frequency components are rejected or attenuated, thus eliminating or mitigating thermal inputs which have not passed through and thus has not been modulated by pass and block frequency f1 of optical shutter 120. Output of filter circuitry 212 is processed by signal estimation circuitry 210, as described above with respect to FIG. 2A.

FIG. 2C is a schematic illustrating a control circuitry 206, a signal estimation circuitry 210, and a bandpass filter 292 of sensing system 100 of FIGS. 1A-1D. Thus, while FIG. 2B illustrates a general filter circuitry 212 (which may include appropriate types of filters), FIG. 2C illustrates an example in which the filter circuitry 212 comprises a bandpass filter 292. The bandpass filter 292 outputs light signal 112, which is modulated at the shutter frequency f1 (see FIG. 1E), while rejecting other frequency components, thus eliminating or mitigating thermal inputs which have not passed through and thus has not been modulated by pass and block frequency f1 of optical shutter 120.

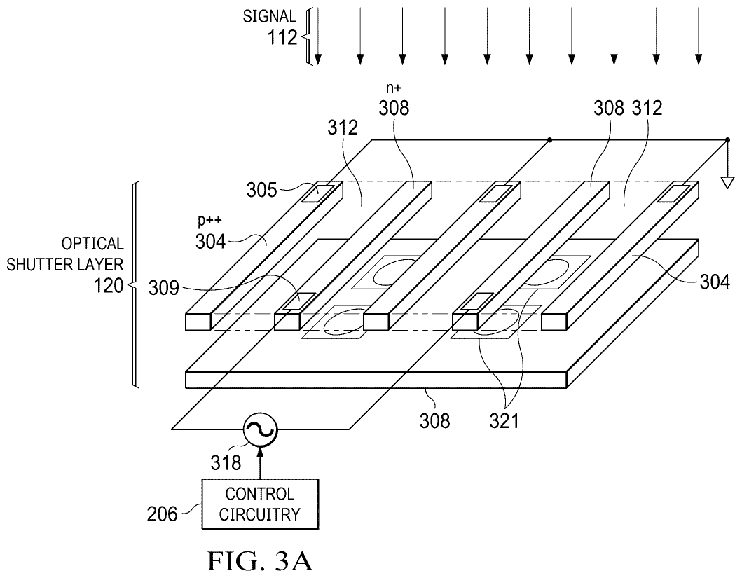

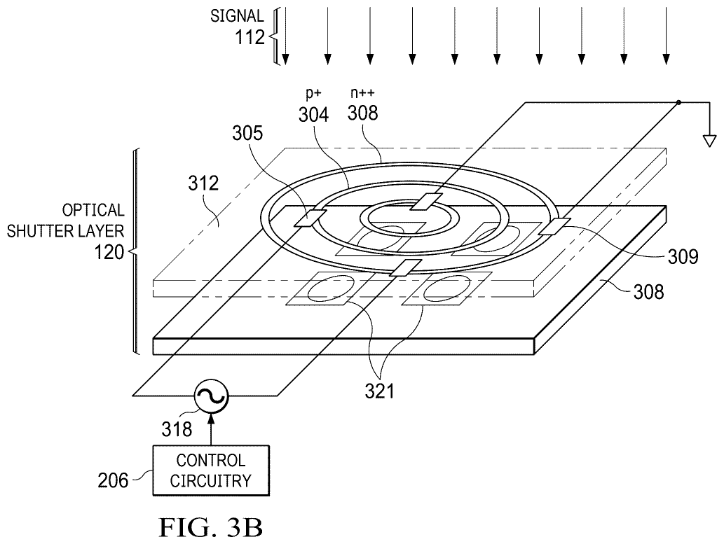

FIGS. 3A and 3B are schematics illustrating example implementations of optical shutter layer 120 of sensing system 100 of FIGS. 1A-1D. The sensor 104 in FIGS. 3A-3B is illustrated to include a plurality of sensor cells 321. A number, a shape, and/or a size of sensor cells 321 in FIGS. 3A and 3B are provided as illustrative examples and may vary.

Referring to FIG. 3A, illustrated are a plurality of diodes. For example, one or more (such as all) of the diodes may be PIN diodes (e.g., with a corresponding plurality of p-i-n junctions). A PIN diode has an undoped intrinsic semiconductor region between a p-type semiconductor region and an n-type semiconductor region. The p-type and n-type regions may be heavily doped (e.g., compared to doping level of an intrinsic semiconductor region). The intrinsic region is in contrast to an ordinary p-n diode, which does not include any intrinsic region between p-type and n-type regions.

For example, optical shutter layer 120 comprises a plurality of p-type regions 304, and a plurality of n-type regions 308. Between each p-type region 304 and each n-type region 308 is a corresponding region 312. As described below in further detail, free carrier concentration with regions 312 are varied, to correspondingly vary a transparency (or opaqueness) of regions 312 for wavelength range of light signal 112, thereby causing optical shutter layer 120 to transition between pass state 188 and block state 189. Such variation of regions 312 may be achieved by varying a biasing of diodes of optical shutter layer 120, as also described below in further detail.

In some examples where the diodes are PIN diodes, regions 312 are intrinsic regions, such as undoped or lightly doped regions. However, in other examples where the diodes are PN diodes, regions 312 are highly doped regions. In an example where the diodes are PIN diodes and regions 312 are intrinsic regions, there are a plurality of interdigitated p-i-n junctions within optical shutter layer 120.

In a p-type region 304, dopants used are acceptor impurities, which create an abundance of holes or positive charge carriers within p-type region 304. The acceptor impurity p-type dopants may be elements from Group III of the periodic table, as they have one or more (such as three) valence electrons and can accept an extra electron, leading to hole formation. In an example, optical shutter layer 120 comprises silicon, and dopants or acceptor impurities within p-type regions 304 may include boron, aluminum, gallium, indium, and/or another appropriate type of p-type dopant.

In an n-type region 308, dopants used are donor impurities, which introduce an excess of free electrons or negative charge carriers within n-type region 308. The donor impurities or n-type dopants may be elements from Group V of the periodic table, as they have one or more (such as five) valence electrons and can donate an extra electron to conduction band. In an example, optical shutter layer 120 comprises silicon, and dopants or donor impurities within n-type regions 304 may include phosphorus, arsenic, antimony, bismuth, and/or another appropriate type of n-type dopant.

In an example where regions 312 are intrinsic regions, regions 312 comprise intrinsic semiconductor material, such as silicon that is undoped or relatively lightly doped (e.g., compared to a doping level of p- or n-type regions). For example, regions 312 comprise boron (or another dopant) doped at 1e13 cm⁻³ to 1e17 cm⁻³ doping concentration.

Each p-type region 304 has a corresponding p-type electrode 305. Similarly, each n-type region 308 has a corresponding n-type electrode 309.

P-type electrodes 305 are coupled to a first voltage source (e.g., coupled to ground terminal). N-type electrodes 309 are coupled to a second voltage source 318. In an example where optical shutter layer 120 operates at a prespecified frequency f1, voltage source 318 is an alternating current (AC) voltage source providing an AC voltage to p-i-n junctions with frequency f1. In an example, control circuitry 206 controls voltage source 318, to operate voltage source 318 at prespecified frequency f1.

In an example, diodes of optical shutter layer 120 are PIN diodes and regions 312 are intrinsic regions (such as undoped or relatively lightly doped regions). In such an example, when p-i-n junctions are forward biased (e.g., by voltage source 318), free carriers fill intrinsic regions 312, thereby increasing a free carrier concentration within regions 312. Due to this increase in free carrier concentration within regions 312, a transparency of regions 312 (e.g., for wavelength range of interest, such as wavelength range of light signals 112) decreases and optical shutter layer 120 operates in the block state. However, when p-i-n junctions are unbiased or reverse biased (e.g., by voltage source 318), free carriers move out of intrinsic regions 312, thereby decreasing a free carrier concentration within regions 312. Due to this decrease in free carrier concentration within regions 312, a transparency of regions 312 (e.g., for wavelength range of interest, such as wavelength range of light signals 112) increases and optical shutter layer 120 operates in the pass state. Thus, a transparency of regions 312 may be controlled, by controlling a biasing of p-i-n junctions within optical shutter layer 120.

In another example, diodes of optical shutter layer 120 are PN diodes and regions 312 are relatively highly doped regions. In such an example, when p-n junctions are reverse biased (e.g., by voltage source 318), free carriers are removed from regions 312, thereby decreasing a free carrier concentration within regions 312. Due to this decrease in free carrier concentration within regions 312, a transparency of regions 312 (e.g., for wavelength range of interest, such as wavelength range of light signals 112) increases and optical shutter layer 120 operates in the pass state. However, when p-n junctions are unbiased or forward biased (e.g., by voltage source 318), free carriers move in regions 312, thereby increasing a free carrier concentration within regions 312. Due to this increase in free carrier concentration within regions 312, a transparency of regions 312 (e.g., for wavelength range of interest, such as wavelength range of light signals 112) decreases and optical shutter layer 120 operates in the block state.

In FIG. 3A, optical shutter layer 120 includes interdigitated p-type regions 304, n-type regions 308, and regions 312, where each region 312 is laterally between a corresponding p-type region 304 and a corresponding n-type region 308. The p-type regions 304, n-type regions 308, and regions 312 are arranged in forms of fingers, as illustrated in FIG. 3A. Also, in FIG. 3B, one or more p-type regions 304, one or more n-type regions 308, and one or more regions 312 (where each region 312 is between a corresponding p-type region 304 and a corresponding n-type region 308) are arranged in concentric ring regions. Each concentric ring region can be of various shape, such as a circular/oval shape (as shown in FIG. 3B), or a polygonal shape.

The shape and/or the number of p-type regions 304, n-type regions 308, and/or regions 312 illustrated in FIGS. 3A and 3B are mere examples, and other shapes and/or other number of p-type regions 304, n-type regions 308, and/or regions 312 may also be possible.

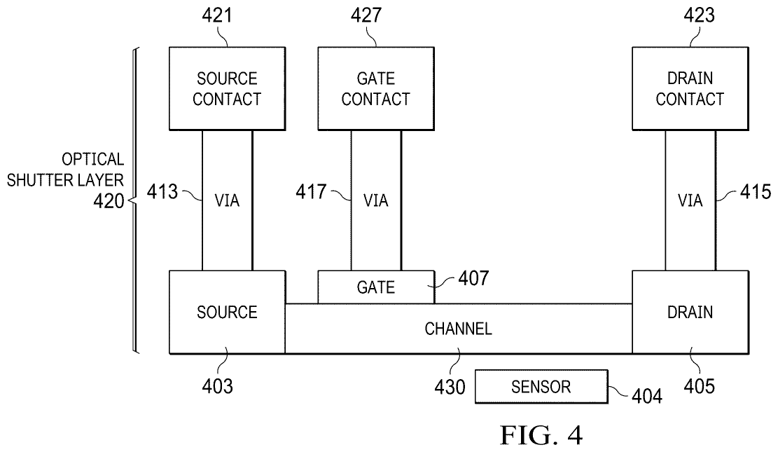

In FIGS. 3A and 3B, free carrier concentrations within regions 312 are controlled by controlling bias voltage applied across corresponding diodes. However, free carrier concentrations may be varied by one or more other manners as well, in an example. FIG. 4 illustrates an optical shutter layer 420 implemented using a transistor. Optical shutter layer 420 is statically placed to overlap at least a part of a sensor 404. Optical shutter layer 420 and sensor 404 may be used in any sensing system 100 of FIGS. 1A-1D.

Optical shutter layer 420 comprises a source region 403, a drain region 405, and a channel 430 laterally between source region 403 and region 405. A gate region 407 is on channel 430. A top-gate configuration or a bottom-gate configuration (or even a double-gate configuration where both a top-gate and a bottom-gate are present) may be possible.

A source contact 421, a drain contact 423, and a gate contact 427, respectively, contacts source region 403, drain region 405, and gate region 407. Source contact 421 is coupled to source region 403 through a conductive via 413, drain region 405 is coupled to drain contact 423 through a conductive via 415, and gate region 407 is coupled to gate contact 427 through a conductive via 417.

In an example, transistor of optical shutter layer 120 is a thin film transistor (TFT), such as a field effect transistor (FET). In an example, transistor of optical shutter layer 120 is a metal oxide semiconductor field-effect transistor (MOSFET).

In an example, channel 430 statically overlaps at least in part sensor 404. For example, a free carrier concentration within channel 430 may be varied, so as to control a transparency of channel 430, and transition channel 430 between a pass state and a block state.

In an example, channel 430 comprises one or more layers of metal oxide. Appropriate metal oxides may be used, to achieve a desired level of transparency in pass state 188 and block state 189 and for wavelength range of interest. For example, different metal-oxides may have different transparencies for density of electrons and for different wavelength ranges. In an example, channel 430 comprises one or more layers of indium oxide (In2O3), indium-tin-oxide (ITO), tin oxide, indium gallium zinc oxide (IGZO), indium tungsten oxide (IWO), indium-zirconium-oxide, zirconium oxide, indium-zinc-oxide, gallium oxide, and/or one or more other metal oxides.

In some examples, the transistor of optical shutter layer 420 is a depletion mode NMOS (N-channel Metal-Oxide-Semiconductor). In such examples, if drain region 405 is at a high voltage, a portion of channel 430 from drain region 405 to gate region 407 may be depleted of charge, e.g., thereby reducing a free carrier concentration within at least a portion channel 430 overlapping with sensor 404. Accordingly, the depleted portion of channel 430 can become more transparent (e.g., optical shutter layer 420 operates in pass state 188).

On the other hand, if drain region 405 at a low voltage (e.g., at or near 0 V, such as less than 0.1 V) and channel 430 is on (e.g., gate voltage is above a threshold voltage), channel 430 has a relatively high concentration of electrons. This increases a free carrier concentration within at least a portion channel 430 overlapping with sensor 404, thereby rendering at least portion channel 430 to be less transparent (e.g., optical shutter layer 420 operates in block state 189).

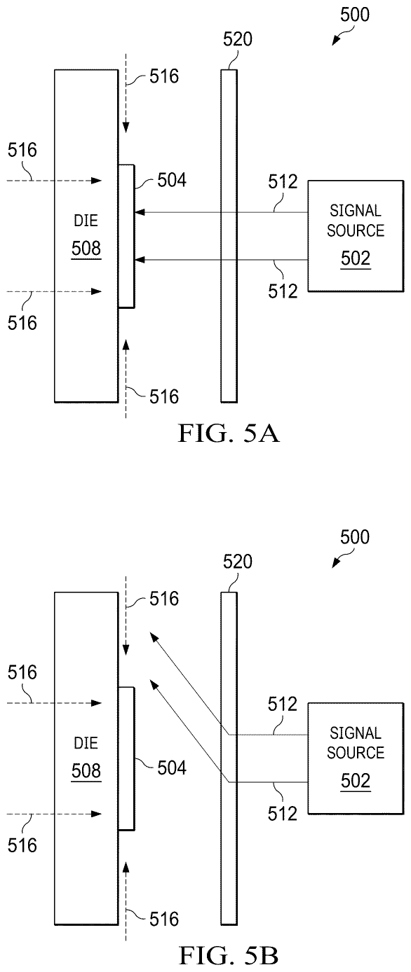

FIGS. 5A and 5B is a schematic illustrating a sensing system 500 having an optical shutter layer 520 on a sensor 504, wherein optical shutter layer 520 selectively steers light signal 512 towards or away from sensor 504 responsive to an electrical signal. FIG. 5A illustrates a pass state of operation of sensing system 500, and FIG. 5B illustrates a block state of operation of sensing system 500.

Sensing system 500 of FIGS. 5A and 5B are at least in part similar to sensing system of FIGS. 1A-1D. For example, similar to sensing system 100, sensing system 500 includes a sensor 504 on a die 508. Sensor 504 receives crosstalk 516, and also receives light signal 512 of interest from a signal source 502. Optical shutter layer 520 is placed to statically overlap at least a part of sensor 504.

Optical shutter layer 520 operates either (i) at a pass state (see FIG. 5A), where light signal 512 is directed towards sensor 504, or (ii) at a block state (see FIG. 5B), where light signal 512 is directed away sensor 504 and hence, substantially blocked from reaching sensor 504. Thus, while sensing system 100 of FIG. 1A-1D varies transparency of optical shutter layer 120, sensing system 500 of FIG. 5A-5B employs variation of a periodicity of a refractive index modulation of optical shutter layer 520 to steer light either towards or away from sensor 504.

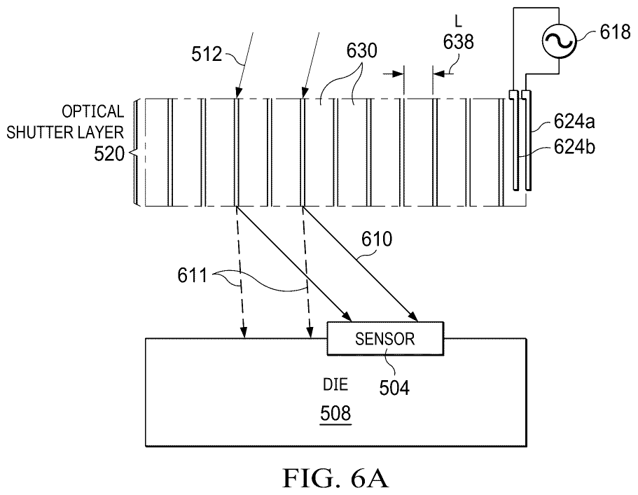

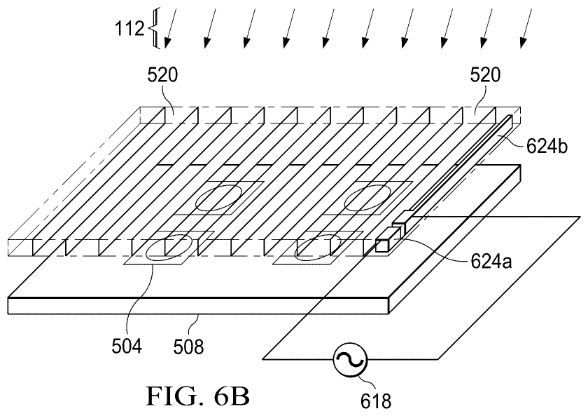

FIGS. 6A and 6B is a schematic illustrating example implementations of optical shutter layer 520 of FIGS. 5A and 5B. Referring to FIGS. 5A, 5B, 6A, and 6B, in an example, optical shutter layer 520 comprises a piezoelectric film or piezoelectric layer. Example piezoelectric material of optical shutter layer 520 may include piezoelectric aluminum scandium nitride (AlScN), lithium niobate (LiNbO₃), and/or other piezoelectric material.

An AC voltage source 618 is coupled to piezoelectric material of optical shutter layer 520, via electrodes 624a and 624b. In an example, an AC transducer attached to a piezoelectric window can be used to introduce a periodic perturbation in optical shutter layer 520, which selectively directs light signal 512 towards or away from sensor 504. For example, optical shutter layer 520 forms a Bragg cell. A Bragg cell, also known as an acousto-optic modulator (AOM), uses interaction between light and sound waves to control intensity, frequency, and/or direction of an incoming light beam (such as light signal 512). Bragg cell operates based on Bragg diffraction principle. A transducer (e.g., comprising piezoelectric material) is attached to a transparent medium. When an electrical signal is applied (e.g., by voltage source 618), the transducer generates an acoustic wave that propagates through the medium. The acoustic wave creates periodic variations in the refractive index of the medium, forming a diffraction grating, symbolically labelled as 630 in FIG. 6A. The grating has a periodicity or pitch L (also labelled as 638), as also illustrated in FIG. 6A. When light signal 512 enters the medium, it interacts with this moving grating 630, causing light to diffract at a diffraction angle that depends on the acoustic wave frequency and power.

In an example, adjusting the acoustic frequency changes a periodicity of a refractive index modulation of the piezoelectric film, thereby changing the diffraction angle, allowing steering of light signal 512. For example, when voltage source 618 is operated at a first frequency Fa, light signal 512 may take path 611 (shown in dotted lines in FIG. 6A), and is steered away from sensor 504 (e.g., optical shutter layer 520 operates in block state).

On the other hand, for example, when voltage source 618 is operated at a second frequency Fb (which is different from first frequency Fa), light signal 512 may take path 610 (shown in solid lines in FIG. 6A), and is steered towards from sensor 504 (e.g., optical shutter layer 520 operates in pass state). Thus, by changing a frequency of voltage source 618, light signal 512 can be steered towards or away from sensor 504.

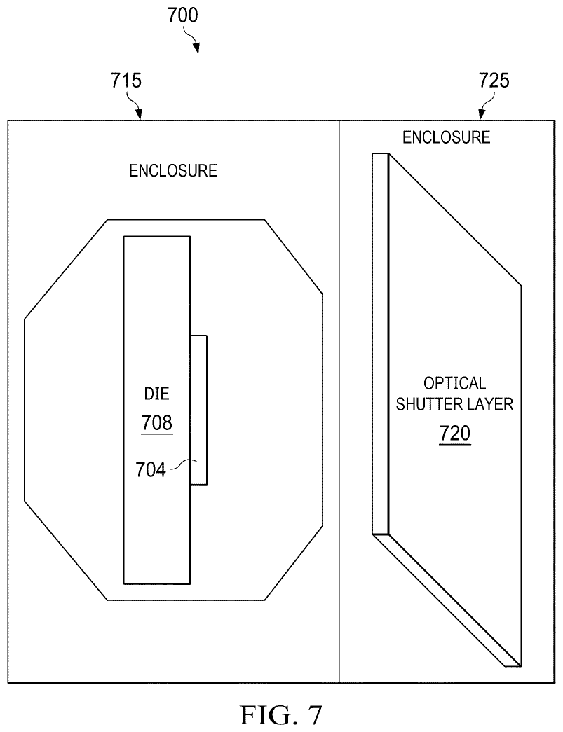

FIG. 7 is a schematic illustrating a sensing arrangement 700 including an optical shutter layer 720 placed statically to overlap at least in part with a sensor 704 that is mounted on a die 708, wherein optical shutter layer 720 is part of an enclosure 725 in front of sensor 704. Optical shutter layer 720 can be any of the optical shutter layers described above with respect to FIGS. 1A-6B. Sensor 704 can be any of the sensors described above with respect to FIGS. 1A-6B.

In an example, die 708 including sensor 704 is within an enclosure 715. Sensing arrangement 700 further includes another enclosure 725 in front of enclosure 715. Thus, enclosure 725 is between sensor 704 and a signal source that may be placed in front of sensor 704.

In an example, enclosure 725 is a cap 730 that is implemented at a front of sensor 704. In an example, enclosure 725 may block incoming visible light from reaching sensor 704 (note that the sensor is configured to sense IR light signals). Thus, while enclosure 725 may block visible light, enclosure 725 selectively at least in part allows to pass light signals in IR range to either reach sensor 704, or at least in part blocks light signals in IR range from reaching sensor 704. For example, enclosure 725 comprises optical shutter layer 720. For example, optical shutter layer 720 may be embedded within enclosure 725. In an example, cap 730 and optical shutter layer 720 may comprise the same material, such as silicon or another semiconductor material, or any of the material of the optical shutter layer described above.

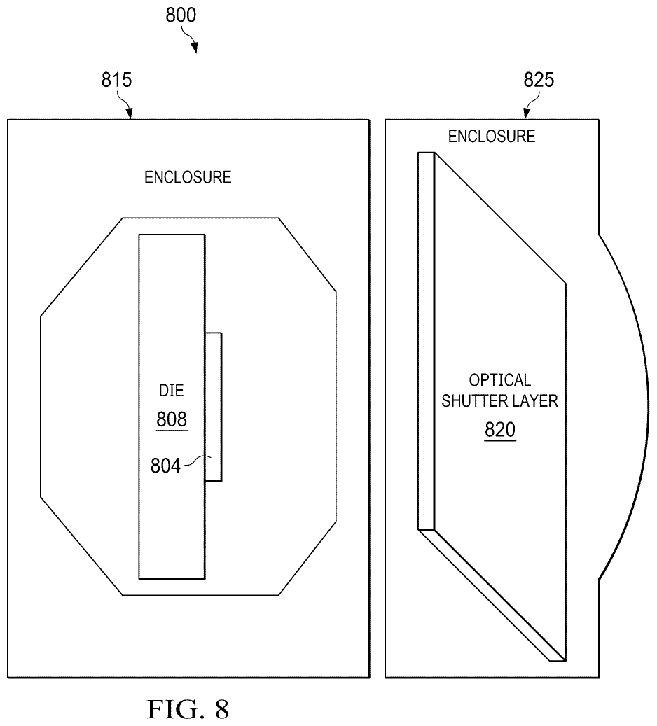

FIG. 8 is a schematic illustrating a sensing arrangement 800 including an optical shutter layer 820 placed statically to overlap at least in part with a sensor 804 that is mounted on a die 808, wherein optical shutter layer 820 is part of a lens enclosure 825 in front of sensor 804. Optical shutter layer 820 can be any of optical shutter layers described above with respect to FIGS. 1A-6B. Sensor 804 can be any of the sensors described above with respect to FIGS. 1A-6B.

In an example, die 808 including sensor 804 is within an enclosure 815. Sensing arrangement 800 further includes another enclosure 825 in front of enclosure 815. Thus, enclosure 825 is between sensor 804 and a signal source that may be placed in front of sensor 804.

In an example, enclosure 825 forms a lens 830 that is implemented at a front of sensor 804. In an example, lens 830 facilitates in focusing of IR light signals from a signal source to sensor 804. In an example, enclosure 825 may also block incoming visible light from reaching sensor 804 (note that sensor 804 is configured to sense IR light signals in wavelength of interest).

In an example, enclosure 825 comprises optical shutter layer 820. For example, optical shutter layer 820 may be embedded within enclosure 825. In an example, lens 830 and optical shutter layer 820 may comprise the same material, such as silicon or another semiconductor material, or any of the material of the optical shutter layer described above.

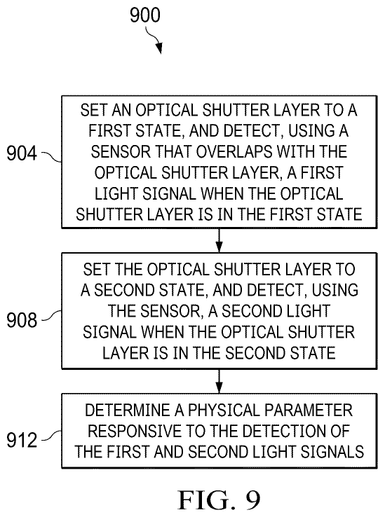

FIG. 9 illustrates a flowchart depicting a method 900 for operating a sensing system including an optical shutter layer. The sensing system may be any of the sensing systems described above. The optical shutter layer may be any of the optical shutter layers described above.

The method 900 comprises at 904, setting an optical shutter layer to a first state, and detecting, using a sensor that overlaps with the optical shutter layer, a first light signal when the optical shutter layer is in the first state. The first state may be, for example, the above-described pass state of the optical shutter layer.

The method 900 comprises at 908, setting the optical shutter layer to a second state, and detecting, using the sensor, a second light signal when the optical shutter layer is in the second state. The second state may be, for example, the above-described pass block state of the optical shutter layer.

The method 900 comprises at 912, determining a physical parameter responsive to the detection of the first and second light signals, e.g., as described above with respect to equations 2-7.

Following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementations without changing the scope of disclosure.

Example 1. An apparatus comprising: a die including a sensor; and an optical shutter layer that statically overlaps with at least part of the sensor of the die.

Example 2. The apparatus of example 1, wherein the optical shutter layer has a configurable transparency to a light signal responsive to an electrical signal.

Example 3. The apparatus of example 2, wherein light signal is infra-red light having a wavelength range of 4 μm to 12 μm.

Example 4. The apparatus of any of examples 1-3, wherein: the optical shutter layer includes a material having configurable free carrier concentration; and the apparatus further includes control circuitry configured to vary the carrier concentration of a region of the material of the optical shutter layer that overlaps with the sensor.

Example 5. The apparatus of example 4, wherein the material comprises silicon.

Example 6. The apparatus of any of examples 4-5, wherein: the material includes p-i-n junctions, each p-i-n junction including a respective p-type region, a respective n-type region, and a respective intrinsic region, the region including the intrinsic regions; the control circuitry is configured to provide bias voltages across the p-i-n junctions; and the p-i-n junctions are configurable to vary the carrier concentrations of the intrinsic regions responsive to the bias voltages.

Example 7. The apparatus of example 6, wherein the p-i-n junctions include p-type regions, n-type regions, and intrinsic regions in forms of fingers.

Example 8. The apparatus of any of examples 6-7, wherein the p-i-n junctions include p-type regions, n-type regions, and intrinsic regions include concentric circular ring regions.

Example 9. The apparatus of any of examples 6-8, wherein: the control circuitry is configured to, during a first time period, provide first bias voltages across the p-i-n junctions to set first free carrier concentrations in the intrinsic regions, and during a second time period, provide second bias voltages across the p-i-n junctions to set second free carrier concentrations in the intrinsic regions; the intrinsic regions having the first free carrier concentrations have a first degree of transparency to a light signal; and the intrinsic regions having the second free carrier concentration have a second degree of transparency to the light signal.

Example 10. The apparatus of example 4, wherein: the optical shutter layer includes a transistor, the transistor including a first current terminal, a second current terminal, a control terminal, and a channel layer, the channel layer being part of the material, and the sensor of the die overlapping with a region of the channel layer between the control terminal and one of the first or second current terminals.

Example 11. The apparatus of example 10, wherein the channel layer comprises a metal oxide.

Example 12. The apparatus of any of examples 10-11, wherein the channel layer comprises at least one of indium oxide, zinc oxide, gallium oxide, tin oxide, tungsten oxide, zirconium oxide.

Example 13. The apparatus of any of examples 1-12, wherein the optical shutter layer is configurable to: in a first mode, steer a light signal to the sensor; and in a second mode, steer the light signal away from the sensor.

Example 14. The apparatus of example 13, wherein: the optical shutter layer includes a piezoelectric film; and the apparatus further includes control circuitry configured to vary a periodicity of a refractive index modulation of the piezoelectric film.

Example 15. The apparatus of any of examples 1-14, further comprising a cap or a lens on the die, wherein the optical shutter layer is part of the cap or the lens.

Example 16. The apparatus of any of examples 1-15, wherein the optical shutter layer has an operation frequency of at least 10 Hz.

Example 17. The apparatus of any of examples 1-16, wherein the sensor is a thermal sensor.

Example 18. The apparatus of any of examples 1-17, wherein the sensor includes at least one of: a thermopile, or a bulk acoustic wave (BAW) device.

Example 19. The apparatus of any of examples 1-18, wherein the optical shutter layer is configurable to: during a first time period, allow a first amount of light to pass through the optical shutter layer and reach the sensor; and during a second time period, allow a second amount of light to pass through the optical shutter layer and reach the sensor, wherein the second amount is less than the first amount.

Example 20. The apparatus of example 19, further comprising: a signal estimation circuitry configured to estimate a parameter by (i) estimating a crosstalk experienced by the apparatus, based on an output of the sensor during the second time period, (ii) measuring an output of the sensor at the first time period, and (iii) reducing an effect of the estimated crosstalk within the output of the sensor at the first time period.

Example 21. The apparatus of example 20, further comprising: a filter circuitry configured to filter the output of the sensor during the first and second time periods, prior to transmitting the output of the sensor to the signal estimation circuitry.

Example 22. An apparatus comprising: a die including a sensor; and a layer configurable to vary an intensity of a light signal that is incident upon the sensor by at least one of: varying the intensity of the light signal that propagates through the layer onto the sensor, or steering at least some of the light signal away from the sensor.

Example 23. The apparatus of example 22, further comprising: a silicon cap or a silicon lens on the die, wherein the layer is embedded within or is a part of the silicon cap or the silicon lens.

Example 24. A system comprising: a die including a sensor; an enclosure on the sensor, wherein the enclosure includes a layer that is configurable to vary an intensity of a light signal propagates through the layer and is incident upon the sensor; and a signal estimation circuitry configured to estimate a parameter by (i) measuring a first output of the sensor during a first state of the layer, and (ii) measuring a first second of the sensor during a second state of the layer.

Example 25. The system of example 24, wherein the enclosure is a cap or a lens on the sensor.

Example 26. A method comprising: setting an optical shutter layer to a first state; setting the optical shutter layer to a second state; detecting, using a sensor that overlaps with the optical shutter layer, a first light signal when the optical shutter layer is in the first state; detecting, using the sensor, a second light signal when the optical shutter layer is in the second state; and determining a physical parameter responsive to the detection of the first and second light signals.

Example 27. The method of example 26, further comprising: toggling between the first state and the second state of the optical shutter layer with a frequency of at least 10 Hz.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” or “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics, or semiconductor components.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuit. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be in depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN), or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means being within +/−10 percent of that parameter or, if the parameter is zero, a reasonable range of values around zero.

What is claimed is:

1. An apparatus comprising:
a die including a sensor; and
an optical shutter layer that statically overlaps with at least part of the sensor of the die.

2. The apparatus of claim 1, wherein the optical shutter layer has a configurable transparency to a light signal responsive to an electrical signal.

3. The apparatus of claim 2, wherein light signal is infra-red light having a wavelength range of 4 μm to 12 μm.

4. The apparatus of claim 1, wherein:
the optical shutter layer includes a material having configurable free carrier concentration; and
the apparatus further includes control circuitry configured to vary the carrier concentration of a region of the material of the optical shutter layer that overlaps with the sensor.

5. The apparatus of claim 4, wherein the material comprises silicon.

6. The apparatus of claim 4, wherein:
the material includes p-i-n junctions, each p-i-n junction including a respective p-type region, a respective n-type region, and a respective intrinsic region, the region including the intrinsic regions;
the control circuitry is configured to provide bias voltages across the p-i-n junctions; and
the p-i-n junctions are configurable to vary the carrier concentrations of the intrinsic regions responsive to the bias voltages.

7. The apparatus of claim 6, wherein the p-i-n junctions include p-type regions, n-type regions, and intrinsic regions in forms of fingers.

8. The apparatus of claim 6, wherein the p-i-n junctions include p-type regions, n-type regions, and intrinsic regions include concentric ring regions.

9. The apparatus of claim 6, wherein:
the control circuitry is configured to, during a first time period, provide first bias voltages across the p-i-n junctions to set first free carrier concentrations in the intrinsic regions, and during a second time period, provide second bias voltages across the p-i-n junctions to set second free carrier concentrations in the intrinsic regions;
the intrinsic regions having the first free carrier concentrations have a first degree of transparency to a light signal; and
the intrinsic regions having the second free carrier concentration have a second degree of transparency to the light signal.

10. The apparatus of claim 4, wherein:
the optical shutter layer includes a transistor, the transistor including a first current terminal, a second current terminal, a control terminal, and a channel layer, the channel layer being part of the material, and the sensor of the die overlapping with a region of the channel layer between the control terminal and one of the first or second current terminals.

11. The apparatus of claim 10, wherein the channel layer comprises a metal oxide.

12. The apparatus of claim 10, wherein the channel layer comprises at least one of indium oxide, zinc oxide, gallium oxide, tin oxide, tungsten oxide, zirconium oxide.

13. The apparatus of claim 1, wherein the optical shutter layer is configurable to:
in a first mode, steer a light signal to the sensor; and
in a second mode, steer the light signal away from the sensor.

14. The apparatus of claim 13, wherein:
the optical shutter layer includes a piezoelectric film; and
the apparatus further includes control circuitry configured to vary a periodicity of a refractive index modulation of the piezoelectric film.

15. The apparatus of claim 1, further comprising a cap or a lens on the die, wherein the optical shutter layer is part of the cap or the lens.

16. The apparatus of claim 1, wherein the optical shutter layer has an operation frequency of at least 10 Hz.

17. The apparatus of claim 1, wherein the sensor is a thermal sensor.

18. The apparatus of claim 1, wherein the sensor includes at least one of: a thermopile, or a bulk acoustic wave (BAW) device.

19. The apparatus of claim 1, wherein the optical shutter layer is configurable to:
during a first time period, allow a first amount of light to pass through the optical shutter layer and reach the sensor; and
during a second time period, allow a second amount of light to pass through the optical shutter layer and reach the sensor, wherein the second amount is less than the first amount.

20. The apparatus of claim 19, further comprising:
a signal estimation circuitry configured to estimate a parameter by (i) estimating a crosstalk experienced by the apparatus, based on an output of the sensor during the second time period, (ii) measuring an output of the sensor at the first time period, and (iii) reducing an effect of the estimated crosstalk within the output of the sensor at the first time period.

21. The apparatus of claim 20, further comprising:
a filter circuitry configured to filter the output of the sensor during the first and second time periods, prior to transmitting the output of the sensor to the signal estimation circuitry.

22. An apparatus comprising:
a die including a sensor; and
a layer configurable to vary an intensity of a light signal that is incident upon the sensor by at least one of: varying the intensity of the light signal that propagates through the layer onto the sensor, or steering at least some of the light signal away from the sensor.

23. The apparatus of claim 22, further comprising:
a silicon cap or a silicon lens on the die, wherein the layer is embedded within or is a part of the silicon cap or the silicon lens.

24. A system comprising:
a die including a sensor;
an enclosure on the sensor, wherein the enclosure includes a layer that is configurable to vary an intensity of a light signal propagates through the layer and is incident upon the sensor; and
a signal estimation circuitry configured to estimate a parameter by (i) measuring a first output of the sensor during a first state of the layer, and (ii) measuring a first second of the sensor during a second state of the layer.

25. The system of claim 24, wherein the enclosure is a cap or a lens on the sensor.

26. A method comprising:
setting an optical shutter layer to a first state;
setting the optical shutter layer to a second state;
detecting, using a sensor that overlaps with the optical shutter layer, a first light signal when the optical shutter layer is in the first state;
detecting, using the sensor, a second light signal when the optical shutter layer is in the second state; and
determining a physical parameter responsive to the detection of the first and second light signals.

27. The method of claim 26, further comprising:
toggling between the first state and the second state of the optical shutter layer with a frequency of at least 10 Hz.
